(19) United States
(12) Patent Application Publication
(10) Pub. No.: US 2026/0024972 A1
(43) Pub. Date: Jan. 22, 2026

(54) ELECTRICAL CONNECTION BOX

(71) Applicant: SUMITOMO WIRING SYSTEMS, LTD., Mie (JP)

(72) Inventor: Takashi SHIRAKI, Mie (JP)

(21) Appl. No.: 19/264,106

(22) Filed: Jul. 9, 2025

(30) Foreign Application Priority Data
Jul. 22, 2024 (JP) 2024-116899

(51) Int. Cl. H02G 3/08; H01R 4/30; H01R 4/34; H01R 13/688; H01R 25/16; H02G 3/18

(52) U.S. Cl. CPC H02G 3/081; H01R 4/305; H01R 4/34; H01R 13/688; H01R 25/161; H02G 3/18

(57) ABSTRACT

A first electrical connection box 20 includes a housing body 31 open upward, an electrical component 40 provided inside the housing body 31, a first terminal portion 50 provided in an edge part inside the housing body 31, electrically connected to the electrical component 40 and further electrically connected to an external power consumption device, and a fuse 92 to be electrically connected between a third external power supply and the terminal portion 50.

### CROSS-REFERENCE TO RELATED APPLICATIONS

This application is based on and claims priority from Japanese Patent Application No. 2024-116899, filed on Jul. 22, 2024, with the Japan Patent Office, the disclosure of which is incorporated herein in its entirety by reference.

### TECHNICAL FIELD

The present disclosure relates to an electrical connection box.

### BACKGROUND

An electrical connection box provided with a housing body open upward, electrical components such as a busbar for power distribution provided inside the housing body, and terminal portions provided in an edge part inside the housing body is conventionally known (see, for example, Japanese Patent Laid-open Publication No. 2022-007710). The busbar for power distribution is made of a metal plate material and includes a current-carrying portion, a plurality of terminals and a plurality of fusing portions functioning as fuses by being provided between the current-carrying portion and the terminals. An external power supply such as a battery serving as a main power supply is, for example, connected to the current-carrying portion. Further, other external power supplies and various external power consumption devices are connected to the respective terminals via the terminal portions.

### SUMMARY

The electrical connection box as described above may be commonly used for a plurality of vehicle types and the like. If, for example, many external power supplies are connected to the electrical connection box, the amount of heat generation in the busbar for power distribution is increased, for example, if currents are distributed after all the external power supplies are connected to the busbar for power distribution. Thus, there is a problem that the amount of heat generation inside the housing body increases.

The present disclosure aims to provide an electrical connection box capable of reducing the amount of heat generation inside a housing body.

The present disclosure is directed to an electrical connection box with a housing body open upward, an electrical component provided inside the housing body, a terminal portion provided in an edge part inside the housing body, the terminal portion being electrically connected to the electrical component and further electrically connected to an external power consumption device, and a fuse to be electrically connected between an external power supply and the terminal portion.

According to the electrical connection box of the present disclosure, the amount of heat generation inside the housing body can be reduced.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram of a vehicle in one embodiment.

FIG. 2 is a perspective view of a first electrical connection box in the embodiment.

FIG. 3 is a partial exploded perspective view of the first electrical connection box in the embodiment.

FIG. 4 is a partial exploded plan view of the first electrical connection box in the embodiment.

FIG. 5 is a partial exploded perspective view of the first electrical connection box in the embodiment.

FIG. 6 is a section along 6-6 of FIG. 4.

FIG. 7 is a partial plan view of the first electrical connection box in the embodiment.

FIG. 8 is a section along 8-8 of FIG. 7.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure are listed and described.
[1] The electrical connection box of the present disclosure is provided with a housing body open upward, an electrical component provided inside the housing body, a terminal portion provided in an edge part inside the housing body, the terminal portion being electrically connected to the electrical component and further electrically connected to an external power consumption device, and a fuse to be electrically connected between an external power supply and the terminal portion.

According to this configuration, the external power supply is connected to the terminal portion via the fuse, and the terminal portion is connected to each of the electrical component and the external power consumption device. By doing so, a current from the external power supply mainly flows to the external power consumption device without via the electrical component. Thus, the amount of heat generation in the electrical component can be reduced and, consequently, the amount of heat generation inside the housing body can be reduced, for example, as compared to the case where all the current from the external power supply flows to the external power consumption device via the electrical component provided inside the housing body.
[2] In [1] described above, a side cover may be provided which accommodates the fuse inside and is arranged to project outward from the housing body from a part corresponding to the terminal portion.

According to this configuration, since the side cover is provided which accommodates the fuse inside and is arranged to project outward from the housing body from the part corresponding to the terminal portion, the amount of heat generation inside the housing body can be reduced while the enlargement of the housing body is avoided. That is, the amount of heat generation inside the housing body can be reduced while the enlargement of the housing body is avoided, for example, as compared to a configuration in which the fuse is provided inside the housing body.
[3] In [2] described above, the fuse may include a first terminal and a second terminal in the form of flat plates projecting in directions opposite to each other on both ends.

According to this configuration, since the fuse includes the first and second terminals in the form of flat plates projecting in the opposite directions on the both ends, a fuse as an ordinary ready-made product can be, for example, used. Thus, for example, a dedicated fuse needs not be manufactured and cost can be reduced.
[4] In [3] described above, the side cover may include a lower cover and an upper cover for covering the lower cover from above and hold an intermediate busbar in the form of a flat plate for connecting the fuse and the terminal portion, the intermediate busbar and the first terminal may be configured to be fastenable by a first fastening member from above with the upper cover removed from the lower cover, and a wire terminal in a wire with terminal to be connected to the external power supply and the second terminal may be configured to be fastenable by a second fastening member from above with the upper cover removed from the lower cover.

According to this configuration, a pair of the intermediate busbar and the first terminal and a pair of the wire terminal in the wire with terminal to be connected to the external power supply and the second terminal can be both fastened from above, wherefore an assembly operation is facilitated. Further, an angle of an extension direction of the wire with terminal from the second fastening member can be easily and freely set with the second fastening member as a center. Thus, an installation space can be reduced. That is, for example, in a configuration in which the wire with terminal itself is bent to determine the extension direction thereof, it is difficult to bend the wire with terminal with a small radius of curvature. Therefore, there is a concern that the installation space viewed from above becomes larger, but this can be avoided.
[5] In [4] described above, the terminal portion and the intermediate busbar may be configured to be fastenable by a third fastening member from above.

According to this configuration, the pair of the intermediate busbar and the first terminal, the pair of the wire terminal in the wire with terminal to be connected to the external power supply and the second terminal and a pair of the terminal portion and the intermediate busbar can be all fastened from the above, wherefore the assembly operation and a disassembly operation, for example, at the time of maintenance are facilitated.
[6] In any one of [1] to [5] described above, the terminal portion may be provided in a corner part of the housing body when viewed from above.

According to this configuration, since the terminal portion is provided in the corner part of the housing body when viewed from above, a connection position to the external power supply is the corner part of the housing body having high heat dissipation. Therefore, the amount of heat generation inside the housing body can be more reduced.

### Details of Embodiment of Present Disclosure

A specific example of the present disclosure is described below with reference to the drawings. For the convenience of description, some components may be shown in an exaggerated or simplified manner in each drawing. Further, a dimension ratio of each part may be different in each figure. Further, the present invention is not limited to these illustrations, but is represented by claims and intended to include all changes in the scope of claims and in the meaning and scope of equivalents.

### Configuration of Vehicle 10

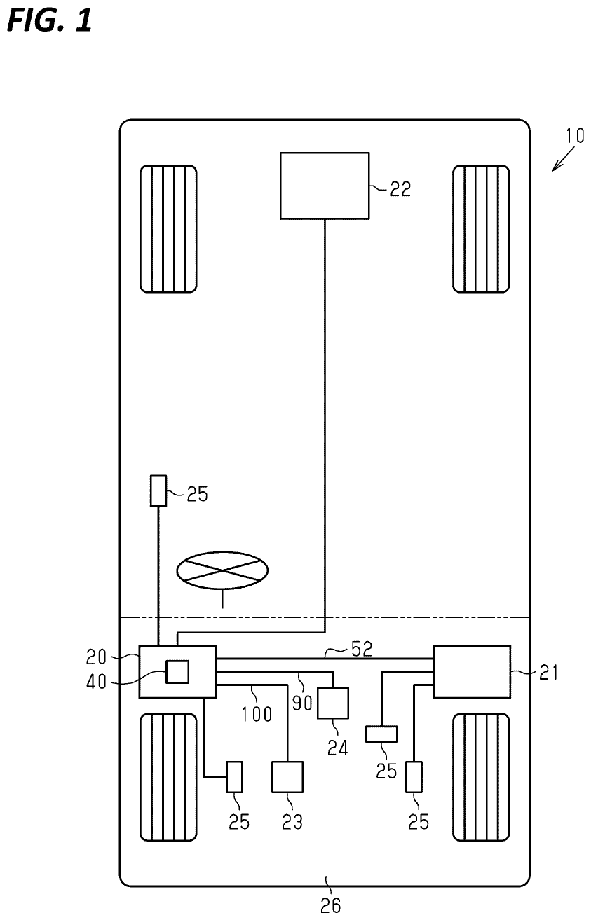

FIG. 1 is a diagram of a vehicle 10 when viewed from above. The vehicle 10 is provided with a first electrical connection box 20 serving as an electrical connection box, a second electrical connection box 21, a first external power supply 22, a second external power supply 23, a third external power supply 24 and a plurality of external power consumption devices 25. The first, second and third external power supply 22, 23 and 24 are, for example, batteries, generators or the like capable of supplying a voltage of several volts. The plurality of external power consumption devices 25 are, for example, various actuators including small-size motors, illumination devices and the like. Note that only four external power consumption devices 25 are schematically shown in FIG. 1.

A lower side in FIG. 1 corresponds to a front side of the vehicle 10. The first and second electrical connection boxes 20, 21 are arranged in an engine compartment 26 provided in the front side of the vehicle 10. The first, second and third external power supplies 22, 23 and 24 are connected to the first electrical connection box 20. The first electrical connection box 20 is connected to the second electrical connection box 21. The plurality of external power consumption devices 25 are connected to the first or second electrical connection box 20, 21. Note that the electrical connection box may be called a junction box, a fuse box, a relay box and the like, but these are collectively called electrical connection boxes in this specification.

### Configuration of First Electrical Connection Box 20

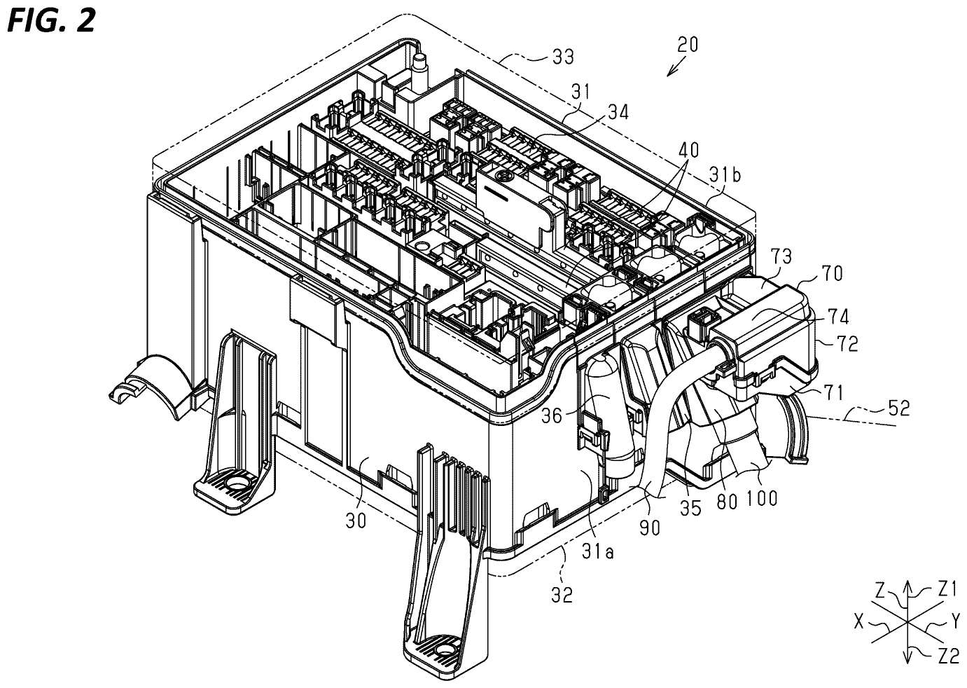

As shown in FIG. 2, the first electrical connection box 20 is provided with a rectangular parallelepiped housing 30. The housing 30 includes a housing body 31 in the form of a rectangular tube open on an upper side Z1 and a lower side Z2, a lower housing 32 for covering the housing body 31 from the lower side Z2, an upper housing 33 for covering the housing body 31 from the upper side Z1 and a holding body 34 to be accommodated inside the housing body 31. Each of the housing body 31, the lower housing 32, the upper housing 33 and the holding body 34 is made of an insulating synthetic resin material.

Note that a first axis X, a second axis Y orthogonal to the first axis X and a third axis Z orthogonal to both the first and second axes X, Y are shown in each figure. Further, an upward direction Z1, which is one direction along the third axis Z and a downward direction Z2, which is a direction opposite to the upward direction Z1, are shown in the figures. Note that the upward direction Z1 mentioned here is an opening direction of the housing body 31 when the first electrical connection box 20 is viewed as a single body, and is not limited to an upward direction strictly orthogonal to a ground in a state installed in the vehicle 10.

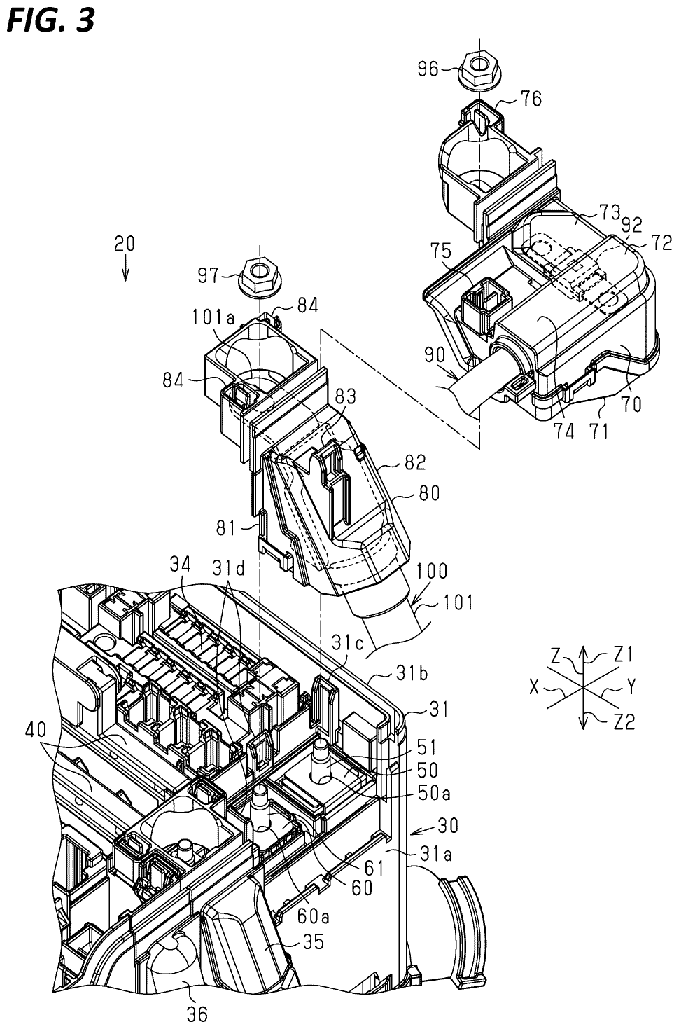

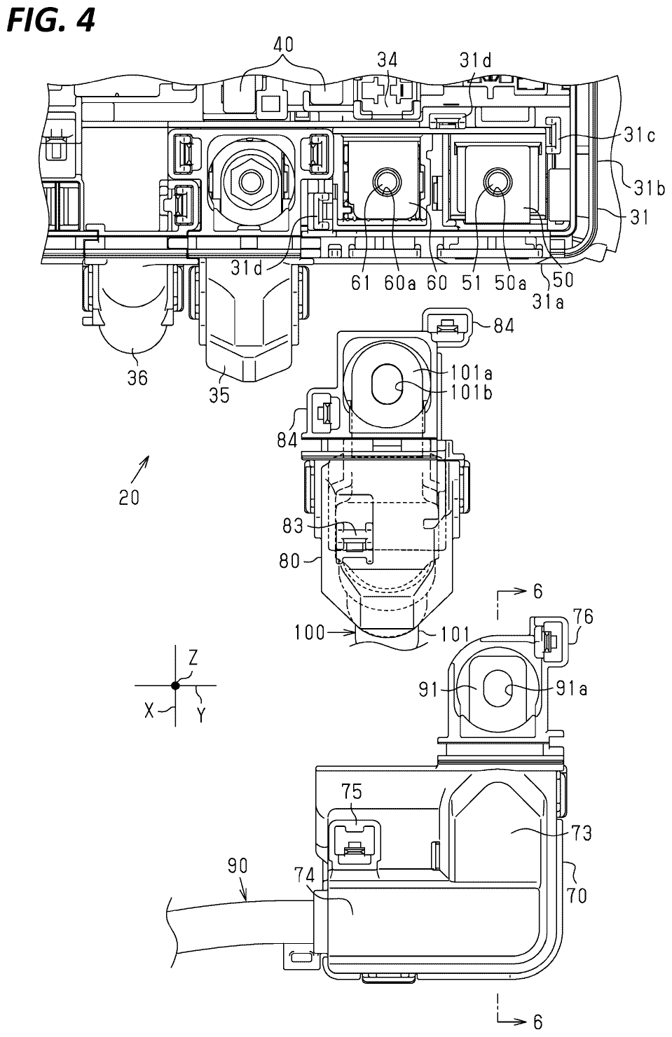

Further, as shown in FIGS. 3 and 4, the first electrical connection box 20 is provided with an electrical component 40, a first terminal portion 50 serving as a terminal portion, a second terminal portion 60, a first side cover 70 serving as a side cover and a second side cover 80. Note that the first electrical connection box 20 of this embodiment is further provided with a third side cover 35 and a fourth side cover 36, but the configurations of these are not described in detail.

### Configuration of Electric Component 40

The electrical component 40 is held by the holding body 34 and provided inside the housing body 31. The electrical component 40 includes a busbar for power distribution. Note that the busbar for power distribution is a known busbar made of a metal plate material and including a current-carrying portion, a plurality of terminals and a plurality of fusing portions functioning as fuses by being provided between the current-carrying portion and the terminals.

### Configurations of First Terminal Portion 50 and Second Terminal Portion 60

The first and second terminal portions 50, 60 are parts of a flat plate-like busbar held by the holding body 34. The first and second terminal portions 50, 60 are so provided that flat surfaces, which are contact surfaces, face in the upward direction Z1.

The first terminal portion 50 is provided in an edge part inside the housing body 31. Note that the edge part mentioned here is a part adjacent to an outer surface 31a of the housing body 31 when viewed from the upper side Z1. Further, the first terminal portion 50 is provided in a corner part of the housing body 31 when viewed from the upper side Z1. Note that the corner part mentioned here is a part adjacent to two orthogonal outer surfaces 31a, 31b of the housing body 31 when viewed from the upper side Z1. The second terminal portion 60 is provided side by side with the first terminal portion 50 in the edge part inside the housing body 31. The second terminal portion 60 is arranged side by side with the first terminal portion 50 along the first axis X.

The first terminal portion 50 includes a first center hole 50a. A first terminal portion bolt 51 is held to pass through the first center hole 50a in the holding body 34. In other words, the first terminal portion bolt 51 is held in the holding body 34 to project toward the upper side Z1 through the first center hole 50a. Further, the first terminal portion 50 is electrically connected to the electrical component 40 inside the housing body 31. In particular, the first terminal portion 50 of this embodiment is connected to the busbar for power distribution in the electrical component 40. Further, the first terminal portion 50 of this embodiment is connected to the second electrical connection box 21 by an electrically conductive member 52 (see FIG. 2) drawn out from the lower side Z2 of the housing body 31 and electrically connected to the plurality of external power consumption devices 25 via the second electrical connection box 21.

The second terminal portion 60 includes a second center hole 60a. A second terminal portion bolt 61 is held to pass through the second center hole 60a in the holding body 34. In other words, the second terminal portion bolt 61 is held in the holding body 34 to project toward the upper side Z1 through the second center hole 60a. Further, the second terminal portion 60 is electrically connected to the electrical component 40 inside the housing body 31. In particular, the second terminal portion 60 of this embodiment is connected to the busbar for power distribution in the electrical component 40.

### Configurations of First Side Cover 70 and Second Side Cover 80

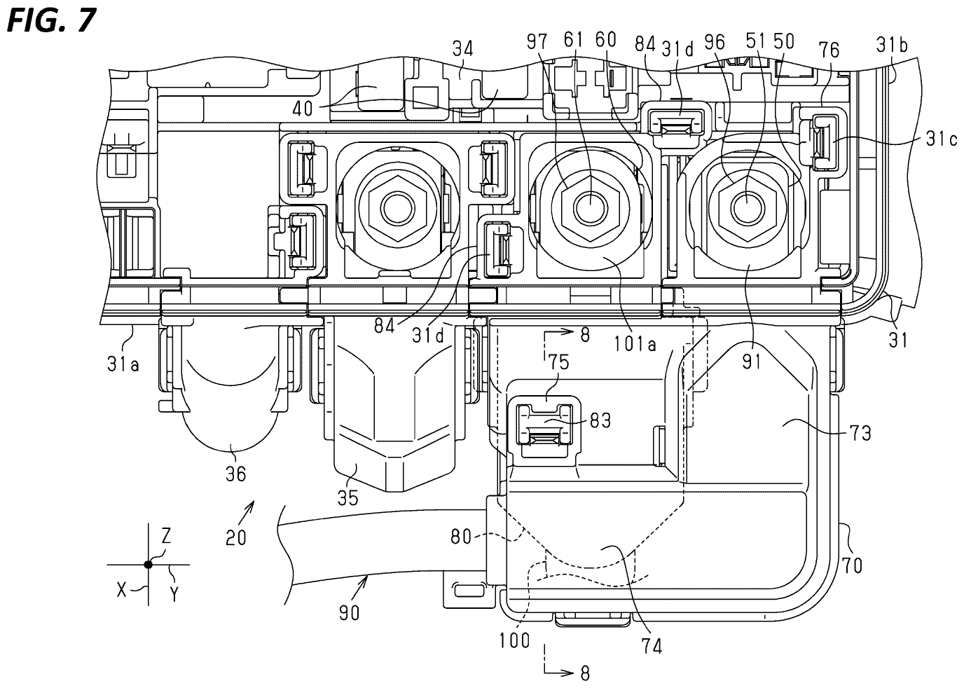

As shown in FIG. 7, the first side cover 70 is arranged to project outward from the housing body 31 from a part corresponding to the first terminal portion 50 (see FIG. 4). Further, the second side cover 80 is arranged to project outward from the housing body 31 from a part corresponding to the second terminal portion 60 (see FIG. 4). The first side cover 70 of this embodiment accommodates a part of a first electrically conductive member 90 connecting the third external power supply 24 (see FIG. 1) serving as an external power supply and the first terminal portion 50. Further, the second side cover 80 of this embodiment accommodates a part of a second electrically conductive member 100 connecting the second external power supply 23 (see FIG. 1) and the second terminal portion 60. A part of the first side cover 70 is provided to overlap the second side cover 80 when viewed from the upper side Z1.

In particular, as shown in FIG. 3, the first side cover 70 includes a first lower cover 71 serving as a lower cover and a first upper cover 72 serving as an upper cover for covering the first lower cover 71 from the upper side Z1. Further, the second side cover 80 includes a second lower cover 81 and a second upper cover 82 for covering the second lower cover 81 from the upper side Z1. Each of the first lower cover 71, the first upper cover 72, the second lower cover 81 and the second upper cover 82 is made of an insulating synthetic resin material.

As shown in FIG. 7, the second side cover 80 extends along the second axis Y, which is an axis orthogonal to the outer surface 31a (see FIG. 4) of the housing body 31, when viewed from the upper side Z1 and extends obliquely toward the lower side Z2 (see FIG. 3).

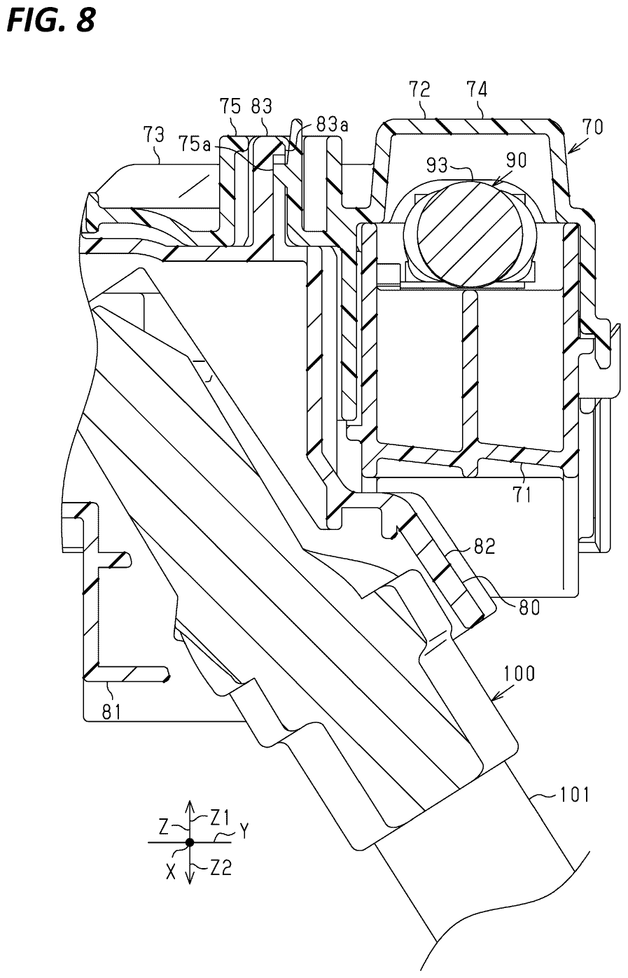

The first side cover 70 includes an outward extending portion 73 extending along the second axis Y, which is the axis orthogonal to the outer surface 31a of the housing body 31, when viewed from the upper side Z, and a bent extending portion 74 bent from the outward extending portion 73 when viewed from the upper side Z and extending to pass above the second side cover 80 on the upper side Z1. As shown in FIGS. 2 and 8, the bent extending portion 74 is arranged in an oblique space formed above the second side cover 80 on the upper side Z1, i.e. in a so-called dead space.

Further, as shown in FIGS. 3 and 8, the second side cover 80 includes an engaged portion 83, and the first side cover 70 includes an engaging portion 75 to be engaged with the engaged portion 83. As shown in FIG. 8, the engaged portion 83 of this embodiment projects toward the upper side Z1 and includes a first claw portion 83a on the tip thereof. Further, the engaging portion 75 is so formed that the engaged portion 83 is insertable thereinto from the lower side Z2, and includes a second claw portion 75a to be engaged with the first claw portion 83a in the upward direction Z1 with the engaged portion 83 inserted. In this way, the first and second side covers 70, 80 are prevented from relatively moving with the engaged portion 83 and the engaging portion 75 engaged.

Further, as shown in FIG. 3, the housing body 31 includes one first cover engaged portion 31c at a position corresponding to the first side cover 70 and two second cover engaged portions 31d at positions corresponding to the second side cover 80. The first side cover 70 includes one first cover side engaging portion 76 to be engaged with the first cover engaged portion 31c, and the second side cover 80 includes two second cover side engaging portions 84 to be engaged with the two second cover engaged portions 31d. Note that the first and second cover engaged portions 31c, 31d are shaped similarly to the engaged portion 83 described above, and the first and second cover side engaging portions 76, 84 are formed similarly to the engaging portion 75 described above. In this way, the second side cover 80 is prevented from relatively moving with respect to the housing body 31 in a state where the two second cover engaged portions 31d and the two second cover side engaging portions 84 are engaged. Further, the first side cover 70 is prevented from relatively moving with respect to the housing body 31 in a state where the first cover engaged portion 31c and the first cover side engaging portion 76 are engaged and the engaged portion 83 and the engaging portion 75 are engaged.

### Configuration of First Electrically Conductive Member 90

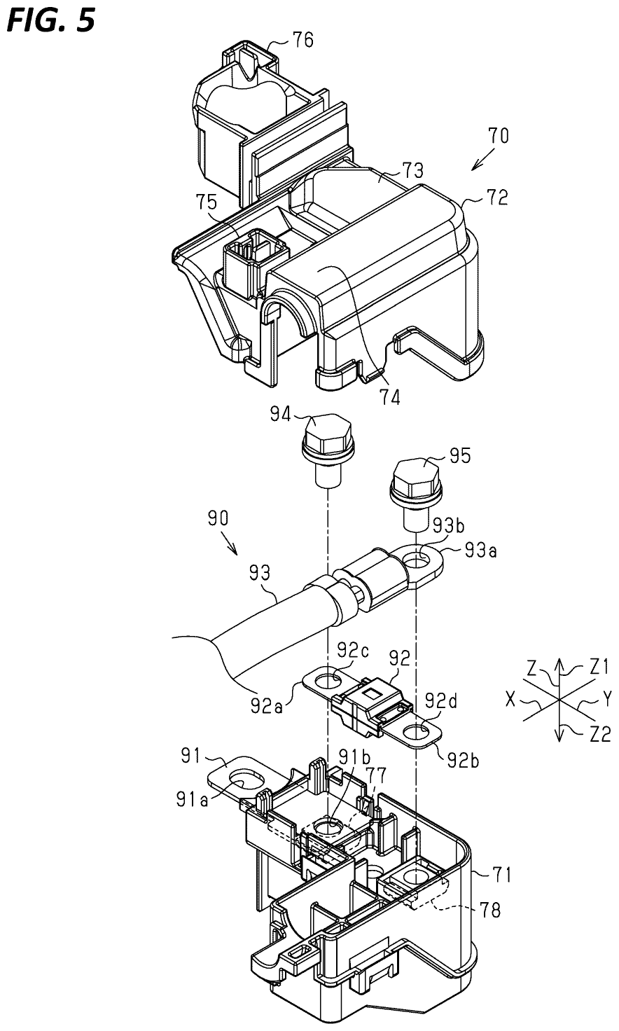

As shown in FIG. 5, the first electrically conductive member 90 for connecting the third external power supply 24 (see FIG. 1) and the first terminal portion 50 (see FIGS. 3 and 4) includes an intermediate busbar 91 in the form of a flat plate, a fuse 92 and a first wire with terminal 93. A part of the intermediate busbar 91, the fuse 92 and a part of the first wire with terminal 93 are accommodated inside the first side cover 70.

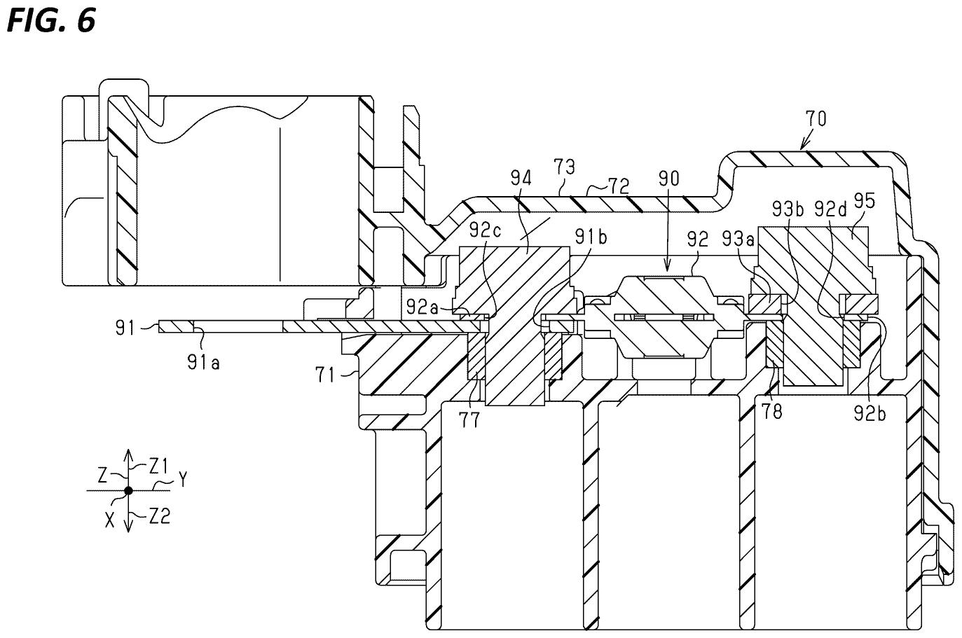

In particular, as shown in FIGS. 5 and 6, the intermediate busbar 91 is held in the first lower cover 71 of the first side cover 70. In the intermediate busbar 91, an end part on a side projecting outward from the first lower cover 71 is arranged to overlap the first terminal portion 50 from the upper side Z1 with the first side cover 70 assembled with the housing body 31 (see FIG. 7). Further, in the intermediate busbar 91, an end part on a side accommodated inside the first lower cover 71 is arranged to overlap a fixing nut 77 held in the first lower cover 71 from the upper side Z1. The intermediate busbar 91 includes a long hole 91a in the end part on the side projecting from the first lower cover 71. Further, the intermediate busbar 91 includes a round hole 91b in the end part on the side accommodated inside the first lower cover 71.

The fuse 92 includes a first terminal 92a and a second terminal 92b in the form of flat plates projecting in directions opposite to each other on both ends. The fuse 92 is so arranged that the first terminal 92a overlaps the end part of the intermediate busbar 91 on the side accommodated inside the first lower cover 71 from the upper side Z1. Further, the fuse 92 is so arranged that the second terminal 92b overlaps a fixing nut 78 held in the first lower cover 71 from the upper side Z1. The respective first and second terminals 92a, 92b include fastening holes 92c, 92d.

The first wire with terminal 93 includes a first wire terminal 93a on an end part opposite to an end part to be connected to the third external power supply 24. The first wire with terminal 93 is so partially accommodated inside the first lower cover 71 that the first wire terminal 93a overlaps the second terminal 92b from the upper side Z1. The first wire terminal 93a includes a round hole 93b.

The intermediate busbar 91 and the first terminal 92a of the fuse 92 are fastened by a first bolt 94 serving as a first fastening member from the upper side Z1 with the first upper cover 72 removed from the first lower cover 71. That is, the intermediate busbar 91 and the first terminal 92a are fastened by the first bolt 94 passed through the fastening hole 92c and the round hole 91b and threadably engaged with the fixing nut 77.

Further, the first wire terminal 93a in the first wire with terminal 93 and the second terminal 92b of the fuse 92 are fastened by a second bolt 95 serving as a second fastening member from the upper side Z1 with the first upper cover 72 removed from the first lower cover 71. That is, the first wire terminal 93a and the second terminal 92b are fastened by the second bolt 95 passed through the round hole 93b and the fastening hole 92d and threadably engaged with the fixing nut 78. Note that the first and second bolts 94, 95 are schematically shown in each figure without showing screw grooves and the like.

As shown in FIG. 7, the first terminal portion 50 and the intermediate busbar 91 are fastened by a first nut 96 serving as a third fastening member from the upper side Z1 with the first side cover 70 assembled with the housing body 31. That is, the first terminal portion 50 and the intermediate busbar 91 are fastened by the first nut 96 threadably engaged with the first terminal portion bolt 51 projecting toward the upper side Z1 while passing through the first center hole 50a (see FIG. 4) and the long hole 91a.

### Configuration of Second Electrically Conductive Member 100

As shown in FIG. 3, the second electrically conductive member 100 for connecting the second external power supply 23 (see FIG. 1) and the second terminal portion 60 includes a second wire with terminal 101. The second wire with terminal 101 includes a second wire terminal 101a on an end part opposite to an end part to be connected to the second external power supply 23.

The second wire with terminal 101 is so partially accommodated and held in the second side cover 80 that the second wire terminal 101a overlaps the second terminal portion 60 from the upper side Z1 with the second side cover 80 assembled with the housing body 31. As shown in FIG. 4, the second wire terminal 101a includes a long hole 101b, through which the second terminal portion bolt 61 can be passed with the second wire terminal 101a overlapped on the second terminal portion 60.

As shown in FIG. 7, the second terminal portion 60 and the second wire terminal 101a are fastened by a second nut 97 from the upper side Z1 with the second side cover 80 assembled with the housing body 31. That is, the second terminal portion 60 and the second wire terminal 101a are fastened by the second nut 97 threadably engaged with the second terminal portion bolt 61 projecting toward the upper side Z1 while passing through the second center hole 60a (see FIG. 4) and the long hole 101b.

### Functions of Embodiment

Next, functions of the first electrical connection box 20 configured as described above are described.

The first electrical connection box 20 is connected to the first, second and third external power supplies 22, 23 and 24 and connected to the second electrical connection box 21 and the plurality of external power consumption devices 25. Power from the first, second and third external power supplies 22, 23 and 24 is supplied to the second electrical connection box 21 and the plurality of external power consumption devices 25 by the first electrical connection box 20.

For example, currents from the first and second external power supplies 22, 23 are supplied to the busbar for power distribution in the electrical component 40 provided inside the first electrical connection box 20, and distributed to the plurality of external power consumption devices 25 via that busbar for power distribution. Further, for example, a current from the third external power supply 24 is mainly supplied to the second electrical connection box 21 via the fuse 92 of the first side cover 70 and distributed to the plurality of external power consumption devices 25 from the second electrical connection box 21 without flowing to the busbar for power distribution in the electrical component 40. Further, only a part of the current from the third external power supply 24 not flowing to the second electrical connection box 21 is supplied to the busbar for power distribution in the electrical component 40 and distributed to the plurality of external power consumption devices 25 via the busbar for power distribution.

### Effects of Embodiment

Next, effects of the above embodiment are described below.
(1) The third external power supply 24 is connected to the first terminal portion 50 via the fuse 92, and the first terminal portion 50 is connected to each of the electrical component 40 provided inside the housing body 31 and the external power consumption devices 25 connected to the second electrical connection box 21. By doing so, a current from the third external power supply 24 mainly flows to the external power consumption devices 25 via the second electrical connection box 21 without via the electrical component 40 including the busbar for power distribution. Thus, the amount of heat generation in the electrical component 40 can be reduced and, consequently, the amount of heat generation inside the housing body 31 can be reduced, for example, as compared to the case where all the current from the third external power supply 24 flows to the external power consumption devices 25 via the electrical component 40 provided inside the housing body 31. Specifically, the amount of heat generation in the busbar for power distribution in the electrical component 40 can be reduced.
(2) Since the first side cover 70 is provided which accommodates the fuse 92 inside and is arranged to project outward from the housing body 31 from the part corresponding to the first terminal portion 50, the amount of heat generation inside the housing body 31 can be reduced while the enlargement of the housing body 31 is avoided. That is, the amount of heat generation inside the housing body 31 can be reduced while the enlargement of the housing body 31 is avoided, for example, as compared to a configuration in which the fuse 92 is provided inside the housing body 31. Further, in this configuration, the existing housing body 31 can be used, for example, even if many external power supplies are connected to the first electrical connection box 20 as in this embodiment.
(3) Since the fuse 92 includes the first and second terminals 92a, 92b in the form of flat plates projecting in the opposite directions on the both ends, the fuse 92 as an ordinary ready-made product can be, for example, used. Thus, for example, a dedicated fuse needs not be manufactured and cost can be reduced.
(4) The intermediate busbar 91 and the first terminal 92a of the fuse 92 are configured to be fastenable by the first bolt 94 from the upper side Z1, and the first wire terminal 93a and the second terminal 92b of the fuse 92 are configured to be fastenable by the second bolt 95 from the upper side Z1. Thus, a pair of the intermediate busbar 91 and the first terminal 92a and a pair of the first wire terminal 93a and the second terminal 92b can be both fastened from the upper side Z1, wherefore an assembly operation is facilitated. Further, in this configuration, an angle of an extension direction of the first wire with terminal 93 from the second bolt 95 can be easily and freely set with the second bolt 95 as a center. That is, as in this embodiment, a relative angle between a longitudinal direction of the fuse 92 and the extension direction of the first wire with terminal 93 can be easily set to a right angle. Thus, an installation space can be reduced. That is, for example, in a configuration in which the first wire with terminal 93 itself is bent to determine the extension direction thereof, it is difficult to bend the first wire with terminal 93 with a small radius of curvature. Therefore, there is a concern that the installation space viewed from the upper side Z1 becomes larger, but this can be avoided.
(5) The first terminal portion 50 and the intermediate busbar 91 are configured to be fastenable by the first nut 96 from the upper side Z1. Thus, the pair of the intermediate busbar 91 and the first terminal 92a, the pair of the first wire terminal 93a and the second terminal 92b and a pair of the first terminal portion 50 and the intermediate busbar 91 can be all fastened from the upper side Z1, wherefore the assembly operation and a disassembly operation, for example, at the time of maintenance are facilitated.
(6) Since the first terminal portion 50 is provided in the corner part of the housing body 31 when viewed from the upper side Z1, a connection position to the third external power supply 24 is the corner part of the housing body 31 having high heat dissipation. Thus, the amount of heat generation inside the housing body 31 can be more reduced.

### Modifications

The above embodiment can be modified and carried out as follows. The above embodiment and the following modifications can be carried out in combination without technically contradicting each other.
Although the fuse 92 provided inside the first side cover 70 includes the first and second terminals 92a, 92b in the form of flat plates projecting in the opposite directions on the both ends in the above embodiment, there is no limitation to this and the fuse 92 may be replaced by a fuse having another shape. For example, the fuse 92 may be replaced by a fuse, in which the first and second terminals 92a, 92b project in parallel, or a fuse having a special shape, which is not a ready-made product.
Although the first side cover 70 includes the first lower cover 71 and the first upper cover 72 in the above embodiment, there is no limitation to this and the first side cover 70 may be changed to have another configuration. Further, although the second side cover 80 includes the second lower cover 81 and the second upper cover 82 in the above embodiment, there is no limitation to this and the second side cover 80 may be changed to have another configuration.
Although the intermediate busbar 91 and the first terminal 92a of the fuse 92 are configured to be fastened by the first bolt 94 from the upper side Z1 in the above embodiment, there is no limitation to this and these may be connected by another configuration. Further, although the first wire terminal 93a and the second terminal 92b of the fuse 92 are configured to be fastened by the second bolt 95 from the upper side Z1, there is no limitation to this and these may be connected by another configuration.
Although the first terminal portion 50 and the intermediate busbar 91 are configured to be fastened by the first nut 96 from the upper side Z1 in the above embodiment, there is no limitation to this and these may be connected by another configuration.
Although the first terminal portion 50 is provided in the corner part of the housing body 31 when viewed from the upper side Z1 in the above embodiment, the first terminal portion 50 may be provided at another position if this position is located in the edge part inside the housing body 31.
Although a part of the first side cover 70 is provided to overlap the second side cover 80 when viewed from the upper side Z1 in the above embodiment, there is no limitation to this and this part may be configured not to overlap the second side cover 80.
Although the second side cover 80 includes the engaged portion 83 and the first side cover 70 includes the engaging portion 75 to be engaged with the engaged portion 83 in the above embodiment, there is no limitation to this and the engaged portion 83 and the engaging portion 75 may not be provided.
Although the housing body 31 includes the one first cover engaged portion 31c and the two second cover engaged portions 31d in the above embodiment, the numbers of the first cover engaged portions 31c and the second cover engaged portions 31d may be changed. Note that, of course, the number of the first cover side engaging portions 76 of the first side cover 70 and the number of the second cover side engaging portions 84 of the second side cover 80 may also be changed in this case.
Although the first side cover 70 is shaped to include the outward extending portion 73 extending along the second axis Y and the bent extending portion 74 bent from the outward extending portion 73 and extending along the first axis X in the above embodiment, there is no limitation to this and the shape of the first side cover 70 may be changed to another shape.
Although the second side cover 80 is shaped to extend along the second axis Y and extend obliquely toward the lower side Z2 in the above embodiment, there is no limitation to this and the shape of the second side cover 80 may be changed to another shape.
Although a part of the first electrically conductive member 90 to be accommodated into the first side cover 70 includes the fuse 92 in the above embodiment, there is no limitation to this and the fuse 92 may not be accommodated inside the first side cover 70.
Although the housing 30 includes the housing body 31, the lower housing 32, the upper housing 33 and the holding body 34 in the above embodiment, the housing 30 may be changed to have another configuration if including at least the housing body 31.
Although the first electrical connection box 20 is connected to the first, second and third external power supplies 22, 23 and 24 in the above embodiment, the number of external power supplies to be connected may be another number. Further, although the first electrical connection box 20 is connected to the second electrical connection box 21, there is no limitation to this and the first electrical connection box 20 may not be connected to the second electrical connection box 21. For example, the first terminal portion 50 may be directly connected to the external power consumption device 25 without via the second electrical connection box 21.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. An electrical connection box, comprising:
a housing body open upward;
an electrical component provided inside the housing body;
a terminal portion provided in an edge part inside the housing body, the terminal portion being electrically connected to the electrical component and further electrically connected to an external power consumption device; and
a fuse to be electrically connected between an external power supply and the terminal portion.

2. The electrical connection box of claim 1, comprising a side cover for accommodating the fuse inside, the side cover being arranged to project outward from the housing body from a part corresponding to the terminal portion.

3. The electrical connection box of claim 2, wherein the fuse includes a first terminal and a second terminal in the form of flat plates projecting in directions opposite to each other on both ends.

4. The electrical connection box of claim 3, wherein:
the side cover includes a lower cover and an upper cover for covering the lower cover from above and holds an intermediate busbar in the form of a flat plate for connecting the fuse and the terminal portion,
the intermediate busbar and the first terminal are configured to be fastenable by a first fastening member from above with the upper cover removed from the lower cover, and
a wire terminal in a wire with terminal to be connected to the external power supply and the second terminal are configured to be fastenable by a second fastening member from above with the upper cover removed from the lower cover.

5. The electrical connection box of claim 4, wherein the terminal portion and the intermediate busbar are configured to be fastenable by a third fastening member from above.

6. The electrical connection box of claim 1, wherein the terminal portion is provided in a corner part of the housing body when viewed from above.
